(19) United States
(12) Patent Application Publication
(10) Pub. No.: US 2005/0211447 A1
(43) Pub. Date: Sep. 29, 2005

(54) Fire tree systems

(76) Inventor: Thomas Joseph McMahon, Spring Hill, FL (US)

Correspondence Address: THOMAS JOSEPH McMAHON, 2 carriage Lane, Levittown, NY, 11756, US

(21) Appl. No.: 11/075,216

(22) Filed: Mar. 9, 2005

Related U.S. Application Data
(60) Provisional application No. 60/555,644, filed on Mar. 24, 2004.

(51) Int. Cl. A62C 11/00

(52) U.S. Cl. 169/51; 169/30; 239/152

(57) ABSTRACT

The Fire Tree, Fire Sprout, and the Pressurized Water Fire Extinguisher Carry Assembly represent a more reliable means of providing temporary, portable fire extinguishers on site, closer to the end user's high valued assets. The Fire Tree Systems are offered with or without portable extinguishers at the end user's discretion. Special or dedicated extinguisher types are also available at the discretion of the end user The system is presented with a deployable storage/transporting container. The storage container is offered with wheels for tarmac or paved site applications, or standard dunage (two peices of 4×4 attached to the base of the storage container in lue of wheels) for off road applications, manual, or fork lift use on surfaces that are other than tarmac or paved.

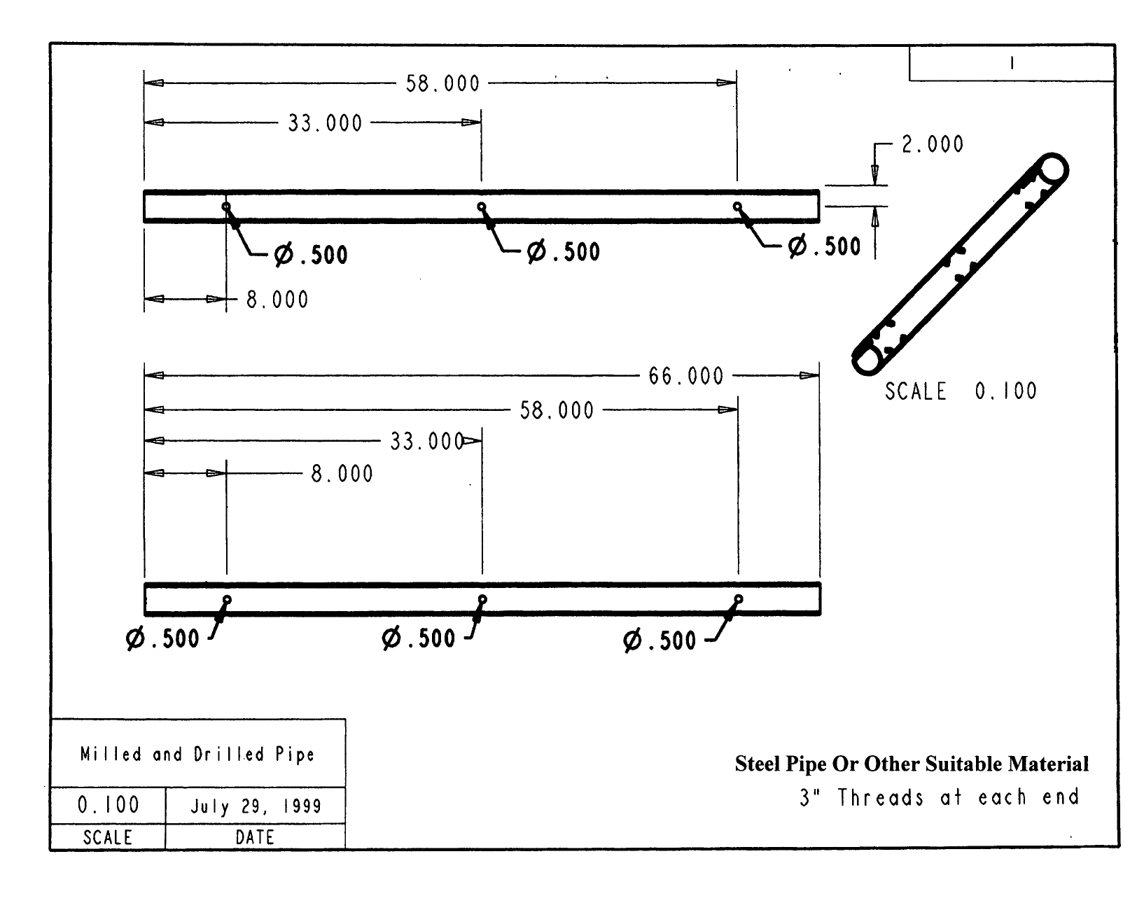

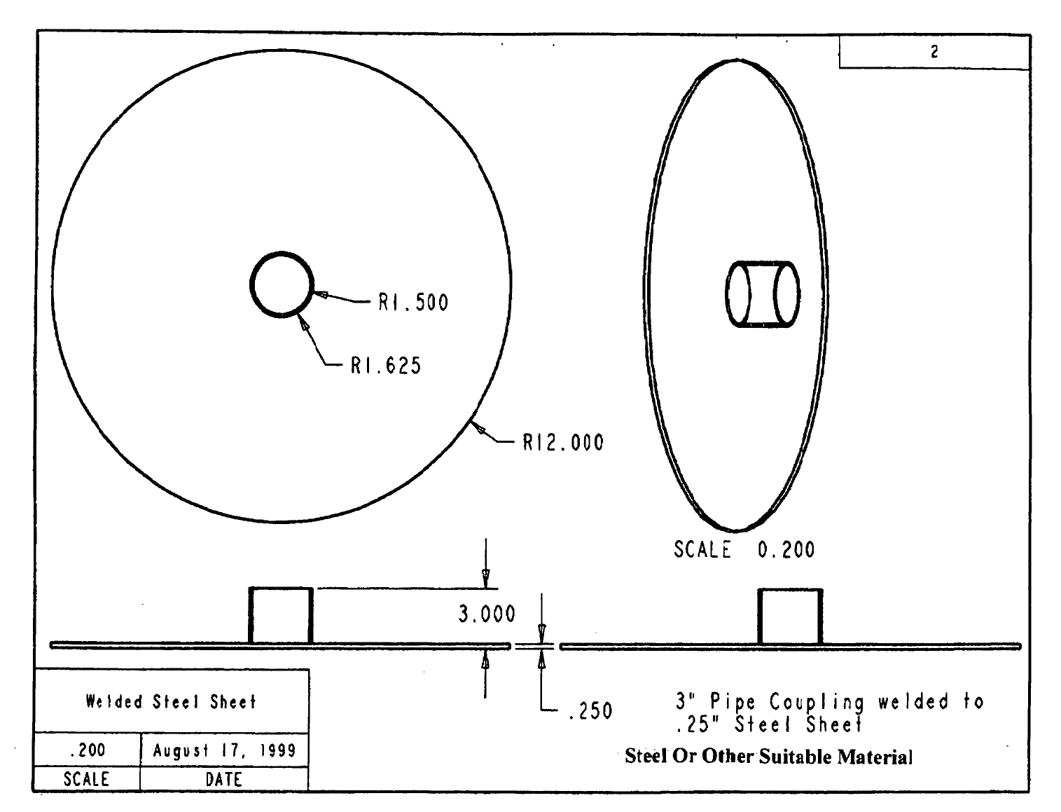

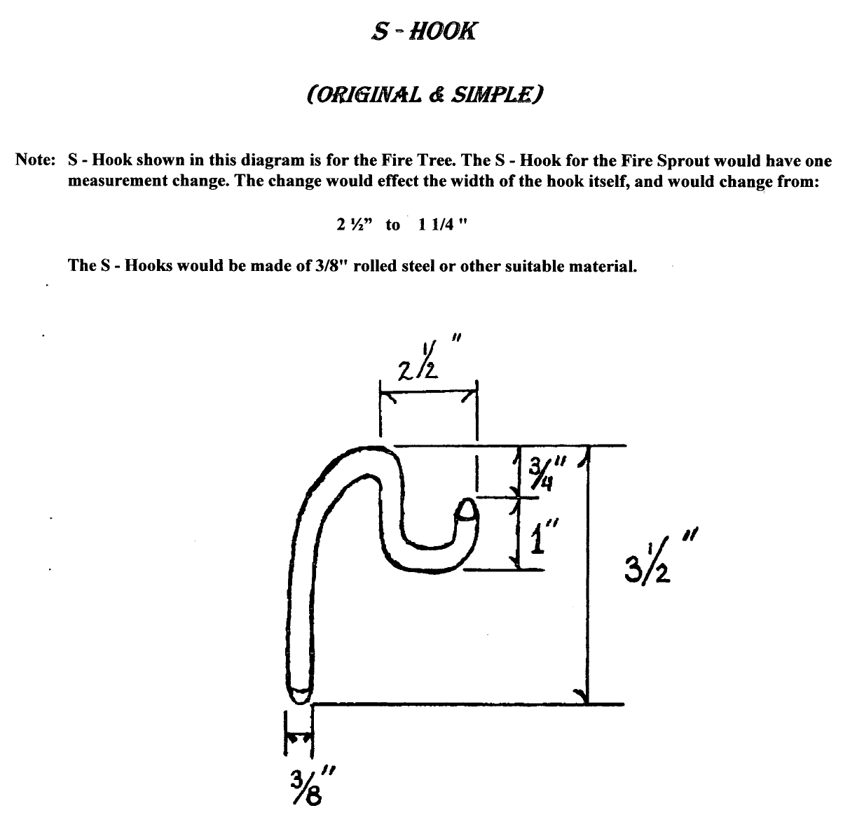

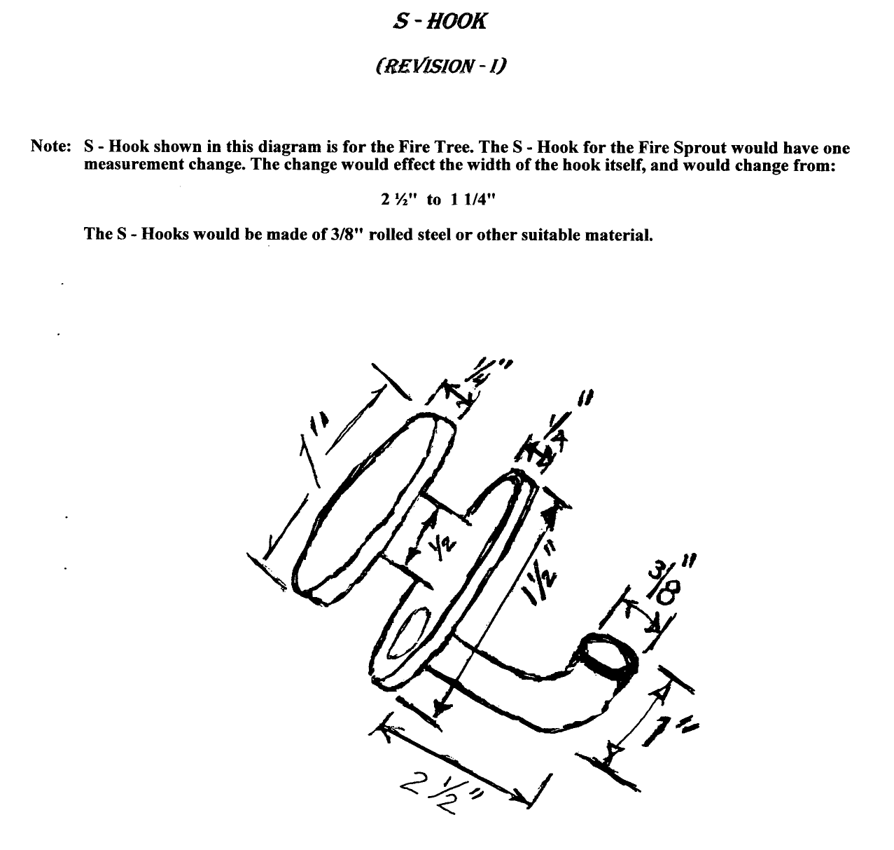

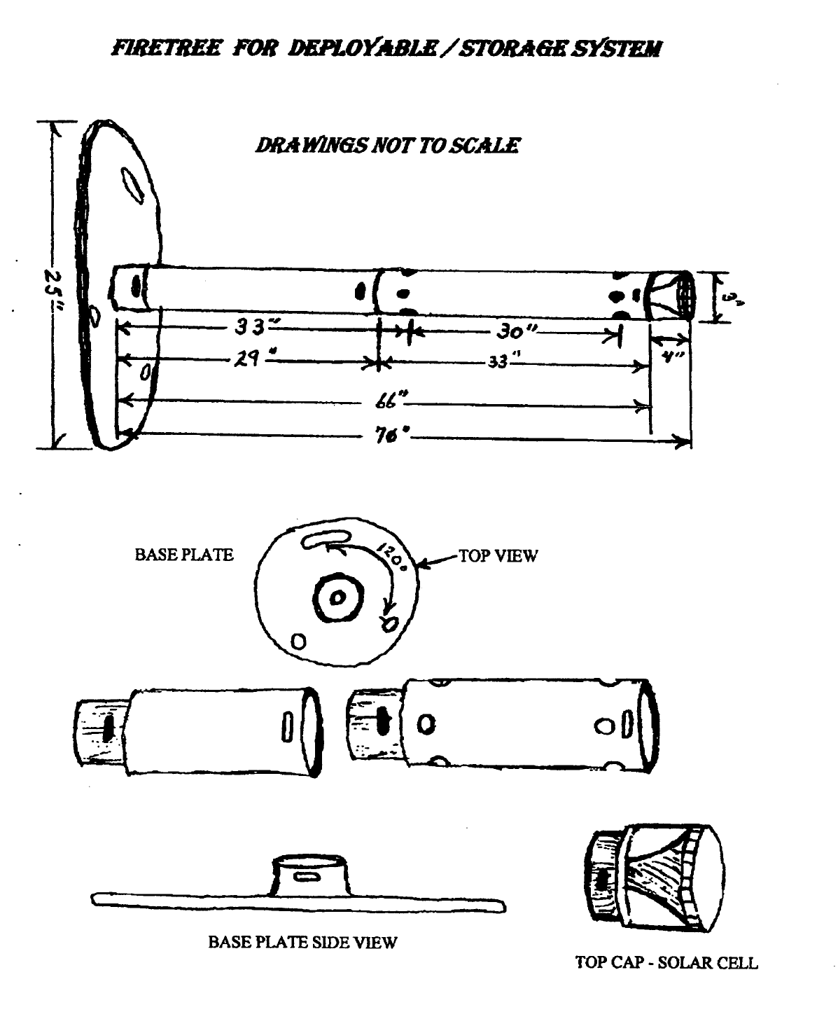

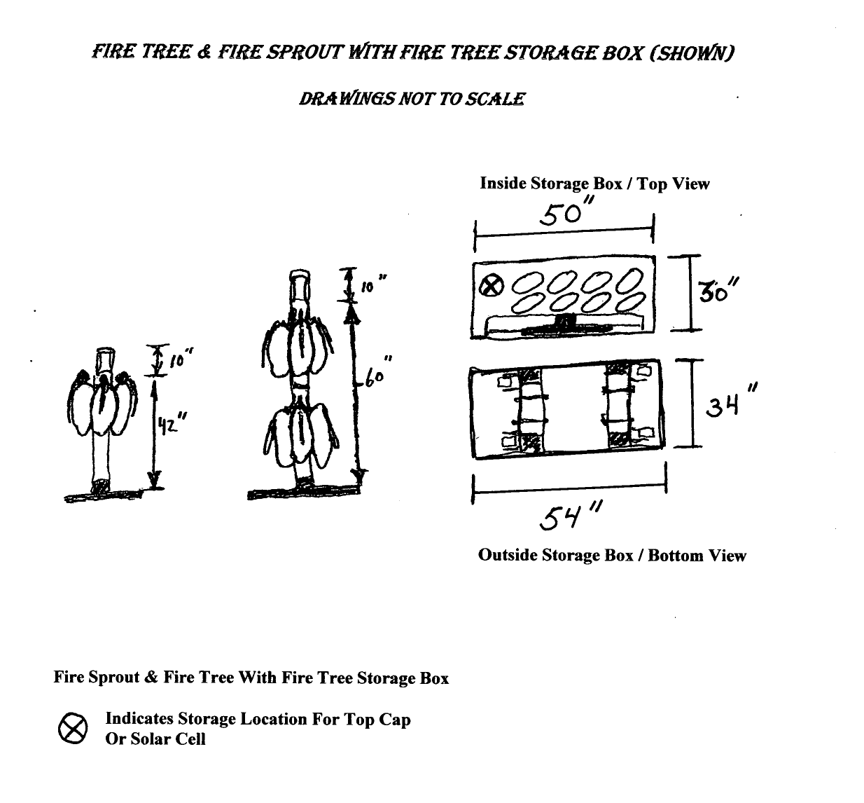

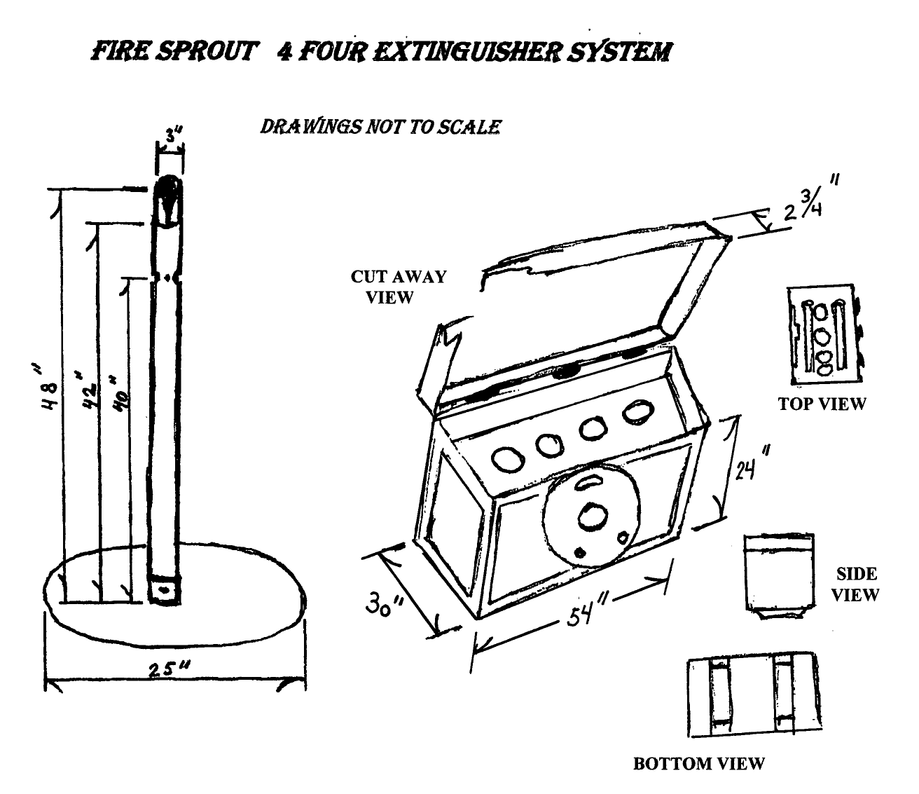

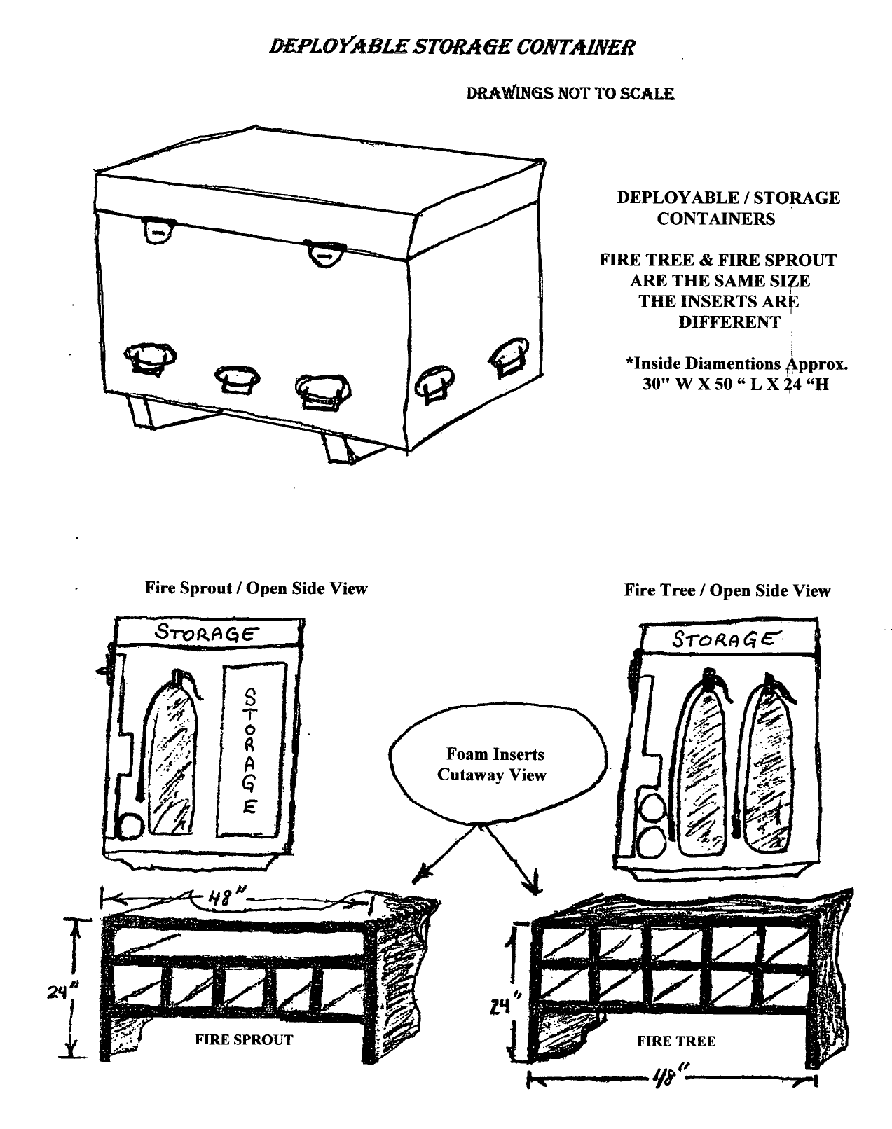

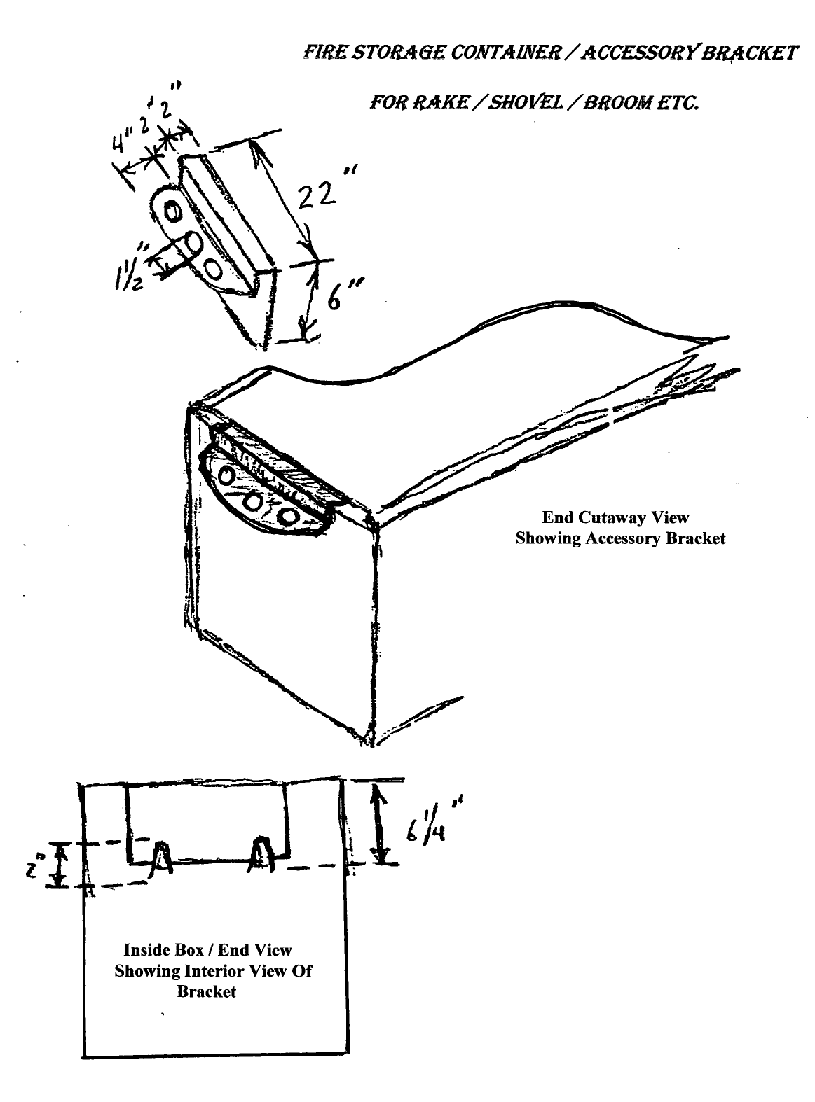

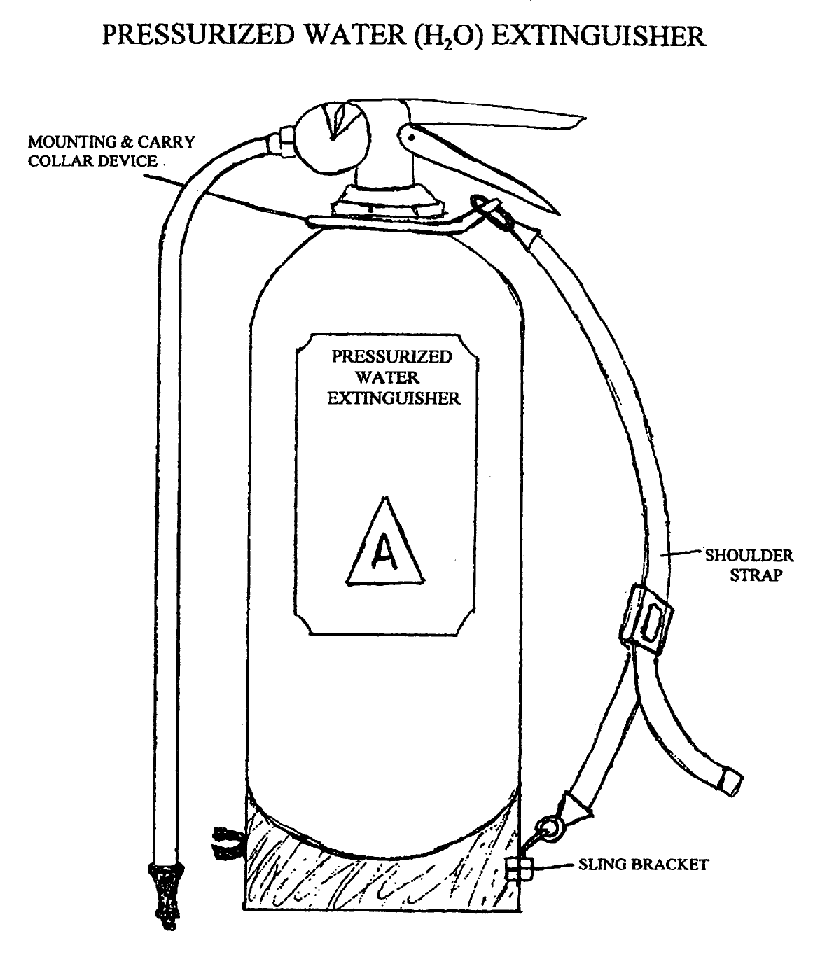

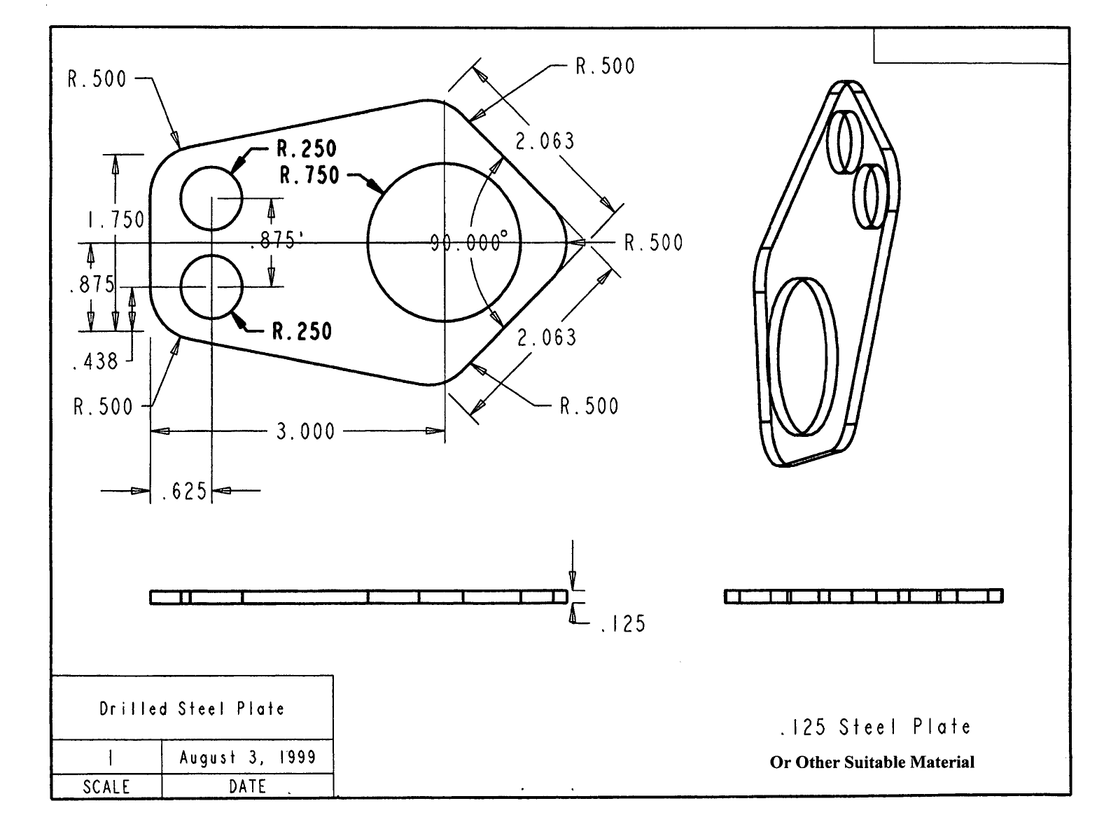

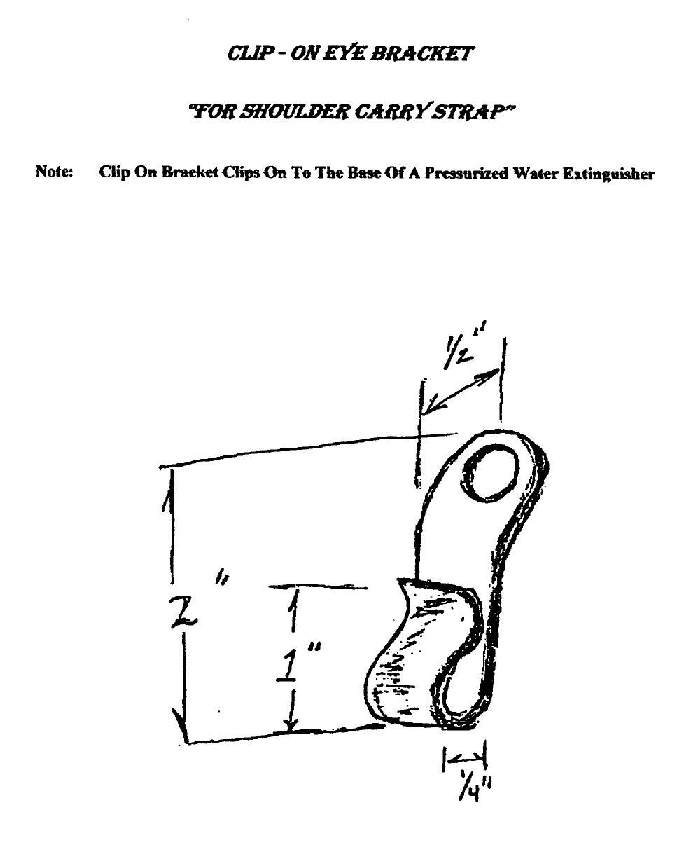

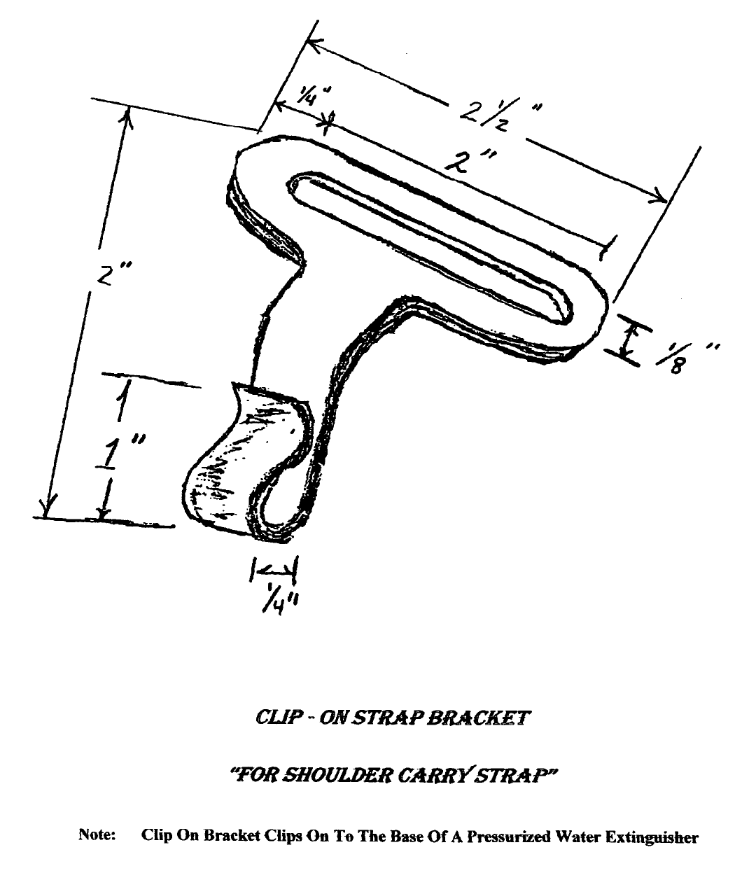

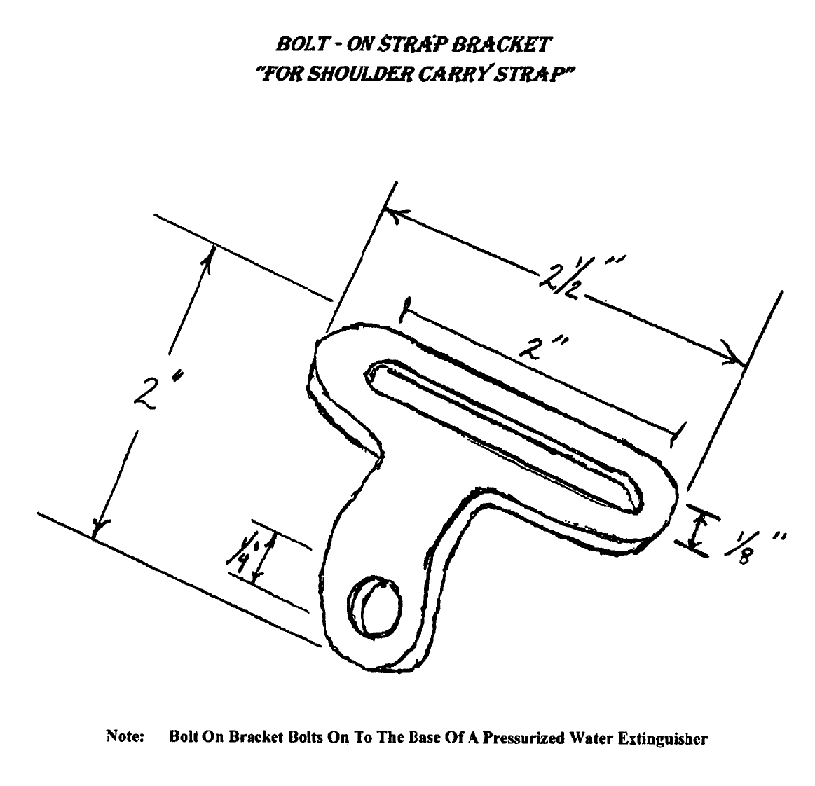

### PRIORITY

This application claims “Priority”. Application No. 60/555,644, Filing Date Mar. 24, 2004, Confirmation #3742

### History

The Fire Tree System was developed to provide an efficient, safe, and effective means of providing a durable portable fire protection accessory that organizes the use of portable fire extinguishers at temporary sites, locations on or off the paved road or tarmac, construction sites where buildings are being altered or constructed, outdoor storage facilities, locations where domestic utilities are disrupted or temporarily out of service, sites with limited emergency service access, and special or temporary sites that are require to provide portable extinguishers by law.

### PORTABLE PRESSURIZED WATER EXTINGUISHER H₂O SHOULDER CARRY ASSEMBLY

1. Reduces Workload on the Heart, Cardiovascular, Back and Muscular System:

Weight suspended from one arm induces cardiovascular strain, back and muscle strain on the side of the body the extinguisher is carried.

A twenty pound load arranged to be carried on the back via the H₂O Shoulder Carry Assembly would subject the carrier to less cardiovascular strain, reduce muscular strain, back strain, and increase the individuals overall effectiveness.

2. Hands Free Deployment:

Shoulder Carry Assembly allows hands free maneuverability for transiting difficult terrain, climbing ladders or climbing to elevated operational sites. Safety advantages of this feature are immeasurable. In DOD/DOT Environments this assembly also provides military personnel the hands free advantage that would allow them to maintain weapons control when transporting extinguishers to a point of operation.

3. Adaptability:

The simplicity of design makes this carry assembly easily adaptable to all free standing H₂O Extinguishers in use in the field today.

4. Exploitation of the H₂O Extinguisher:

Improved end use of the H2O Extinguisher via The Carry System and the ability of DOD/DOT units to restore this extinguisher to full service in the field environment will expand the service applications of this extinguisher to troops. Dust control in Command, and Operational Control Centers. Decontamination resource for limited exposures to personnel and or equipment. Given the resources of DOD/DOT the H₂O Extinguisher will never be out of service in the field and reduce the obligation of the field units to store expended extinguishers that require special treatment and handling in order to be returned to full fire service.

The Fire Tree, Fire Sprout, and the Pressurized Water Fire Extinguisher Carry Assembly represent a more reliable means of providing temporary, portable fire extinguishers on site, closer to the end user's high valued assets. The Fire Tree Systems are offered with or without portable extinguishers at the end user's discretion. Special or dedicated extinguisher types are also available at the discretion of the end user The system is presented with a deployable storage/transporting container. The storage container is offered with wheels for tarmac or paved site applications, or standard dunage (two peices of 4×4 attached to the base of the storage container in lue of wheels) for off road applications, manual, or fork lift use on surfaces that are on other than tarmac or paved.

The Fire Tree and Fire Sprout each consist of a 24″ base plate and a vertical 3″ cylinder pipe with pre drilled holes and removable extinguisher mounting hooks in two distinct styles. A single section vertical 3″ cylinder pipe called the “Fire Sprout”, with four holes drilled. A two section vertical 3″ cylinder pipe called the “Fire Tree” with eight holes drilled. The Fire Sprout provides for the staging of four portable extinguisher, while the Fire Tree provides for the staging of eight portable extinguishers. Also included in the Fire Tree System is the Pressurized Portable Water Extinguisher Shoulder Carry Bracket and Strap Assembly. This assembly allows the Pressurized Portable Water Extinguisher to be mounted on the Fire Tree or Fire Sprout and carried over the shoulder by the end user thus offering the hands free transporting of the Pressurized Water Extinguisher.

Note: The Fire Tree System described and referenced herein, it is not intended that this application be limited thereby, but modifications thereof are intended to be included as falling within the broad scope and spirit of this disclosure.

1. I claim the Fire Tree and Fire Sprout devices, Pressurized Portable Water Extinguisher Shoulder Carry Assembly, the Fire Tree and Fire Sprout provide a stable mounting stanchion for a variety of Portable Fire Extinguisher in remote, temporary and altered location; the device consist of a base plate and a vertical three inch cylinder pipe with removable extinguisher mounting hooks in two distinct styles, a single section called the Fire Sprout, four holes drilled, and a two section called the Fire Tree with eight holes drilled, the Fire Sprout provides for the staging of four portable extinguisher, the Fire Tree provides for the staging of eight portable extinguishers, also included is the Pressurized Portable Water Extinguisher Shoulder Carry Bracket and Strap Assembly, which allows the Pressurized Portable Water Extinguisher to be carried over the shoulder.
